(19) United States
(12) Patent Application Publication
(10) Pub. No.: US 2023/0164721 A1
(43) Pub. Date: May 25, 2023

(54) METHODS AND APPARATUS FOR TRIGGERING A SCHEDULING REQUEST IN NON-TERRESTRIAL NETWORKS

(71) Applicant: FG Innovation Company Limited, Tuen Mun (HK)

(72) Inventors: HSIN-HSI TSAI, Taipei (TW); CHIEN-CHUN CHENG, Taipei (TW); YUNG-LAN TSENG, Taipei (TW); YEN-HUA LI, Taipei (TW)

(21) Appl. No.: 17/994,216

(22) Filed: Nov. 25, 2022

Related U.S. Application Data
(60) Provisional application No. 63/264,585, filed on Nov. 25, 2021.

(51) Int. Cl. H04W 56/00

(52) U.S. Cl. CPC H04W 56/0045

(57) ABSTRACT

A method performed by a user equipment (UE) is provided. In the method, a timing advance (TA) report configuration is received. Whether a TA report(s) (TAR) has been triggered and not cancelled is determined. In a case of determining that the TAR(s) has been triggered and not cancelled, whether an uplink resource(s) is available for a new transmission and the uplink resource(s) accommodates a TAR Media Access Control (MAC) Control Element (CE) and a subheader of the TAR MAC CE as a result of logical channel prioritization (LCP) is determined. In a case of determining that no uplink resource is available for the new transmission, or the uplink resource(s) available for the new transmission does not accommodate the TAR MAC CE and the subheader of the TAR MAC CE as a result of LCP, whether to trigger a scheduling request is determined based on the TA report configuration.

### CROSS-REFERENCE TO RELATED APPLICATION

The present application claims the benefit of and priority to U.S. Provisional Patent Application Ser. No. 63/264,585, filed on Nov. 25, 2021, entitled “UE-SPECIFIC TA REPORT IN NTN,” the contents of which are hereby fully incorporated herein by reference for all purposes.

### FIELD

The present disclosure generally relates to wireless communications and, more particularly, to methods and apparatus for triggering a scheduling request (SR) in non-terrestrial networks (NTN).

### BACKGROUND

With the tremendous growth in the number of connected devices and the rapid increase in user/network traffic volume, various efforts have been made to improve different aspects of wireless communication for next-generation wireless communication systems, such as the fifth-generation (5G) New Radio (NR) system, by improving data rate, latency, reliability, and mobility.

The 5G NR system is designed to provide flexibility and configurability to optimize network services and types, accommodating various use cases such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communication for next-generation wireless communication systems.

### SUMMARY

The present disclosure is directed to methods and apparatus for triggering a scheduling request (SR) in non-terrestrial networks (NTN).

In a first aspect of the present disclosure, a method performed by a UE is provided. The method includes receiving a timing advance (TA) report configuration; determining whether at least one TA report (TAR) has been triggered and not cancelled; in a case of determining that the at least one TAR has been triggered and not cancelled, determining whether at least one uplink resource is available for a new transmission and the at least one uplink resource accommodates a TAR Media Access Control (MAC) Control Element (CE) and a subheader of the TAR MAC CE as a result of logical channel prioritization (LCP); and in a case of determining that no uplink resource is available for the new transmission, or the at least one uplink resource available for new the transmission does not accommodate the TAR MAC CE and the subheader of the TAR MAC CE as a result of LCP, determining whether to trigger a scheduling request (SR) based on the TA report configuration.

In an implementation of the first aspect, the TA report configuration includes a parameter indicating whether to trigger the SR for a TA reporting procedure.

In another implementation of the first aspect, determining whether to trigger the SR based on the TA report configuration includes determining whether the parameter is configured with a value of enabled.

In another implementation of the first aspect, in a case of determining that the parameter is configured with the value of enabled, triggering the SR.

In another implementation of the first aspect, in a case of determining that the at least one uplink resource is available for the new transmission and the at least one uplink resource accommodates the TAR MAC CE and the subheader of the TAR MAC CE as a result of LCP, instructing a multiplexing and assembly procedure to generate the TAR MAC CE.

In another implementation of the first aspect, the TAR MAC CE is associated with one of the at least one TAR that has been triggered and not cancelled.

In another implementation of the first aspect, the UE operates in a non-terrestrial network (NTN).

In a second aspect of the present disclosure, a user equipment (UE) is provided. The UE includes one or more non-transitory computer-readable media storing computer-executable instructions, and at least one processor coupled to the one or more non-transitory computer-readable media. The at least one processor is configured to execute the computer-executable instructions to cause the UE to receive a timing advance (TA) report configuration; determine whether at least one TA report (TAR) has been triggered and not cancelled; in a case of determining that the at least one TAR has been triggered and not cancelled, determine whether at least one uplink resource is available for a new transmission and the at least one uplink resource accommodates a TAR Media Access Control (MAC) Control Element (CE) and a subheader of the TAR MAC CE as a result of logical channel prioritization (LCP); and in a case of determining that no uplink resource is available for the new transmission, or the at least one uplink resource available for the new transmission does not accommodate the TAR MAC CE and the subheader of the TAR MAC CE as a result of LCP, determine whether to trigger a scheduling request (SR) based on the TA report configuration.

In an implementation of the second aspect, the TA report configuration includes a parameter indicating whether to trigger the SR for a TA reporting procedure.

In another implementation of the second aspect, determining whether to trigger the SR based on the TA report configuration includes determining whether the parameter is configured with a value of enabled.

In another implementation of the second aspect, the at least one processor is further configured to execute the computer-executable instructions to cause the UE to, in a case of determining that the parameter is configured with the value of enabled, trigger the SR.

In another implementation of the second aspect, the at least one processor is configured to execute the computer-executable instructions to cause the UE to, in a case of determining that the at least one uplink resource is available for the new transmission and the at least one uplink resource accommodates the TAR MAC CE and the subheader of the TAR MAC CE as a result of LCP, instruct a multiplexing and assembly procedure to generate the TAR MAC CE.

In another implementation of the second aspect, the TAR MAC CE is associated with one of the at least one TAR that has been triggered and not cancelled.

In another implementation of the second aspect, the UE operates in a non-terrestrial network (NTN).

In a third aspect of the present disclosure, a base station (BS) is provided. The BS includes one or more non-transitory computer-readable media storing computer-executable instructions, and at least one processor coupled to the one or more non-transitory computer-readable media. The at least one processor configured to execute the computer-executable instructions to cause the BS to transmit a timing advance (TA) report configuration to a User Equipment (UE), wherein the TA report configuration causes the UE to determine whether at least one TA report (TAR) has been triggered and not cancelled; in a case of determining that the at least one TAR has been triggered and not cancelled, determine whether at least one uplink resource is available for a new transmission and the at least one uplink resource accommodates a TAR Media Access Control (MAC) Control Element (CE) and a subheader of the TAR MAC CE as a result of logical channel prioritization (LCP); and in a case of determining that no uplink resource is available for the new transmission, or the at least one uplink resource available for the new transmission does not accommodate the TAR MAC CE and the subheader of the TAR MAC CE as a result of LCP, determine whether to trigger a scheduling request (SR) based on the TA report configuration.

In an implementation of the third aspect, the TA report configuration includes a parameter indicating whether to trigger the SR for a TA reporting procedure.

In another implementation of the third aspect, determining whether to trigger the SR based on the TA report configuration includes determining whether the parameter is configured with a value of enabled.

In another implementation of the third aspect, the TA report configuration further causes the UE to, in a case of determining that the parameter is configured with the value of enabled, trigger the SR.

In another implementation of the third aspect, the TA report configuration further causes the UE to, in a case of determining that the at least one uplink resource is available for the new transmission and the at least one uplink resource accommodates the TAR MAC CE and the subheader of the TAR MAC CE as a result of LCP, instruct a multiplexing and assembly procedure to generate the TAR MAC CE.

In another implementation of the third aspect, the TAR MAC CE is associated with one of the at least one TAR that has been triggered and not cancelled.

In another implementation of the third aspect, the UE operates in a non-terrestrial network (NTN).

### BRIEF DESCRIPTION OF THE DRAWINGS

Aspects of the present disclosure are best understood from the following detailed description when read with the accompanying figures. Various features are not drawn to scale. Dimensions of various features may be arbitrarily increased or reduced for clarity of discussion.

FIG. 1 is a schematic diagram illustrating a non-terrestrial network (NTN) scenario according to an example implementation of the present disclosure.

FIG. 2 is a schematic diagram illustrating an NTN scenario according to another example implementation of the present disclosure.

FIG. 3 is a flowchart illustrating a method for triggering a scheduling request according to an example implementation of the present disclosure.

FIG. 4 is a block diagram illustrating a node for wireless communication according to an example implementation of the present disclosure.

### DESCRIPTION

Some of the terms mentioned in the present disclosure are defined as follows. Unless otherwise specified, the terms in the present disclosure have the following meanings.

| Abbreviation | Full name |
|---|---|
| 5G-S-TMSI | 5G S-Temporary Mobile Subscriber Identity |
| BA | Bandwidth Adaptation |
| BSR | Buffer Status Report |
| BWP | Bandwidth Part |
| CA | Carrier Aggregation |
| CCCH | Common Control Channel |
| CE | Control Element |
| CH | Channel |
| CORESET | Control Resource Set |
| CSI | Channel State Information |
| CSS | Common Search Space |
| DCI | Downlink Control Information |
| DCP | DCI with CRC scrambled by PS-RNTI |
| DL | Downlink |
| DRX | Discontinuous Reception |
| ID | Identification |
| LBT | Listen Before Talk |
| LSB | Least Significant Bit |
| MAC | Medium Access Control |
| MAC CE | MAC Control Element |
| MCG | Master Cell Group |
| MIMO | Multi-In Multi-Out |
| MSB | Most Significant Bit |
| NID | Network Identifier |
| NR-U | New Radio Unlicensed |
| NTN | Non-Terrestrial Network |
| NW | Network |
| PDCCH | Physical Downlink Control Channel |
| PDSCH | Physical Downlink Shared Channel |
| PDU | Protocol Data Unit |
| PHR | Power Headroom Report |
| PLMN | Public Land Mobile Network |
| PUCCH | Physical Uplink Control Channel |
| PUSCH | Physical Uplink Shared Channel |
| RAR | Random Access Response |
| Rel | Release |
| RLF | Radio Link Failure |
| RNTI | Radio Network Temporary Identifier |
| RRC | Radio Resource Control |
| RRM | Radio Resource Management |
| SCS | Subcarrier Spacing |
| SI | System Information |
| SIB | System Information Block |
| SL | Sidelink |
| SNPN | Standalone Non-Public Network |
| SPS | Semi-Persistent Scheduling |
| SR | Scheduling Request |
| SS | Search Space |
| SSSG | Search Space Set Group |
| UE | User Equipment |
| UL | Uplink |
| USS | UE-specific search space |
| UTR | UE-specific TA Reporting |

The following contains specific information pertaining to example implementations in the present disclosure. The drawings and their accompanying detailed disclosure are directed to merely example implementations of the present disclosure. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features are identified (although, in some examples, not illustrated) by numerals in the example figures. However, the features in different implementations may differ in other respects, and thus shall not be narrowly confined to what is illustrated in the figures.

References to “one implementation,” “an implementation,” “example implementation,” “various implementations,” “in some implementations,” “implementations of the present disclosure,” etc., may indicate that the implementation(s) of the present disclosure may include a particular feature, structure, or characteristic, but not every possible implementation of the present disclosure necessarily includes the particular feature, structure, or characteristic. Further, repeated use of the phrase “In some implementations,” “in an example implementation,” or “an implementation” do not necessarily refer to the same implementation, although they may. Moreover, any use of phrases like “implementations” in connection with “the present disclosure” are never meant to characterize that all implementations of the present disclosure must include the particular feature, structure, or characteristic, and should instead be understood to mean “at least some implementations of the present disclosure” include the stated particular feature, structure, or characteristic. The term “coupled” is defined as connected, whether directly or indirectly through intervening components, and is not necessarily limited to physical connections. The term “comprising,” when utilized, means “including but not necessarily limited to”; it specifically indicates open-ended inclusion or membership in the disclosed combination, group, series, and the equivalent. The terms “system” and “network” in the present disclosure may be used interchangeably.

The term “and/or” herein is only an association relationship for describing associated objects and represents that three relationships may exist. For example, A and/or B may represent that A exists alone, A and B exist at the same time, and B exists alone. “A and/or B and/or C” may represent that at least one of A, B, and C exists. The character “/” used herein generally represents that the former and latter associated objects are in an “or” relationship.

Additionally, for a non-limiting explanation, specific details, such as functional entities, techniques, protocols, standards, and the like, are set forth for providing an understanding of the disclosed technology. In other examples, detailed disclosure of well-known methods, technologies, systems, architectures, and the like are omitted so as not to obscure the present disclosure with unnecessary details.

Persons skilled in the art will immediately recognize that any network function(s) or algorithm(s) may be implemented by hardware, software, or a combination of software and hardware. Disclosed functions may correspond to modules that may be software, hardware, firmware, or any combination thereof. The software implementation may include computer-executable instructions stored on a computer-readable medium, such as memory or other types of storage devices. For example, one or more microprocessors or general-purpose computers with communication processing capability may be programmed with corresponding executable instructions and carry out the disclosed network function(s) or algorithm(s). The microprocessors or general-purpose computers may be formed of Application-Specific Integrated Circuits (ASICs), programmable logic arrays, and/or one or more Digital Signal Processors (DSPs). Although some of the example implementations disclosed are oriented to software installed and executing on computer hardware, alternative example implementations implemented as firmware, as hardware, or as a combination of hardware and software are well within the scope of the present disclosure.

The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, or an LTE-Advanced Pro system) may typically include at least one Base Station (BS), at least one UE, and one or more optional network elements that provide connection towards a network. The UE may communicate with the network (e.g., a Core Network (CN), an Evolved Packet Core (EPC) network, an Evolved Universal Terrestrial Radio Access Network (E-UTRAN), a Next-Generation Core (NGC), or an Internet) through a Radio Access Network (RAN) established by the BS.

In the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE may be configured to receive and transmit signals over an air interface to one or more cells in a RAN.

A BS may include, but is not limited to, a Node B (NB) as in the Universal Mobile Telecommunication System (UMTS), an evolved Node B (eNB) as in the LTE-A, a Radio Network Controller (RNC) as in the UMTS, a Base Station Controller (BSC) as in the Global System for Mobile communications (GSM)/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UMTS (often referred to as 3G) based on basic Wideband-Code Division Multiple Access (W-CDMA), High-Speed Packet Access (HSPA), LTE, LTE-A, enhanced LTE (eLTE), NR (often referred to as 5G), and LTE-A Pro. However, the scope of the present disclosure should not be limited to the protocols mentioned above.

The BS may be operable to provide radio coverage to a specific geographical area using a plurality of cells included in the RAN. The BS may support the operations of the cells. Each cell may be operable to provide services to at least one UE within its radio coverage. For example, each cell (often referred to as a serving cell) may provide services to serve one or more UEs within its radio coverage (e.g., each cell schedules the Downlink (DL) and optionally Uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Service (ProSe), LTE SL services, and LTE/NR Vehicle-to-Everything (V2X) services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (Pcell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (Scells). An SCG may refer to a group of serving cells associated with the Secondary Node (SN), including the SpCell and optionally one or more Scells.

As discussed above, the frame structure for NR is to support flexible configurations for accommodating various next-generation (e.g., 5G) communication requirements, such as eMBB, mMTC, and URLLC, while fulfilling high reliability, high data rate, and low latency requirements. The orthogonal frequency-division multiplexing (OFDM) technology, as agreed in the 3^{rd} Generation Partnership Project (3GPP), may serve as a baseline for an NR waveform. The scalable OFDM numerology, such as the adaptive sub-carrier spacing, the channel bandwidth, and the cyclic prefix (CP), may also be used. Additionally, two coding schemes are considered for NR: (1) low-density parity-check (LDPC) code and (2) polar code. The coding scheme adaptation may be configured based on the channel conditions and/or the service applications.

Moreover, it is also considered that in a transmission time interval of a single NR frame, at least DL transmission data, a guard period, and UL transmission data should be included, where the respective portions of the DL transmission data, the guard period, and the UL transmission data should also be configurable, for example, based on the network dynamics of NR. Besides, an SL resource may also be provided in an NR frame to support ProSe services.

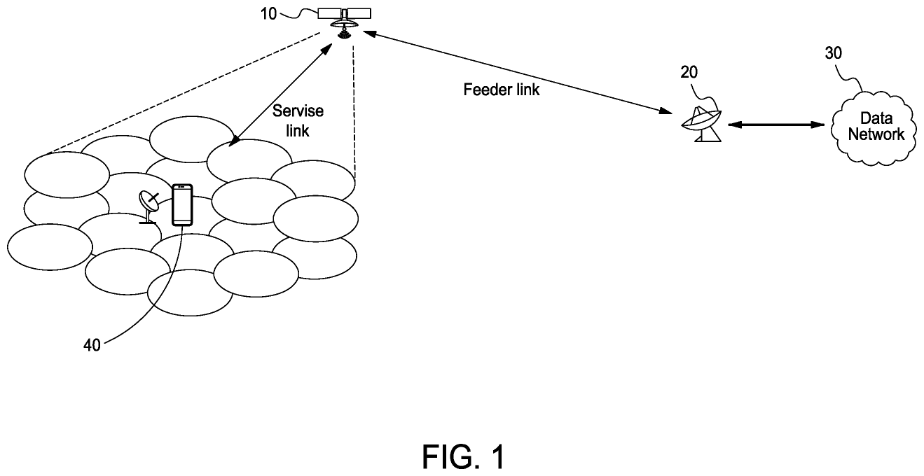

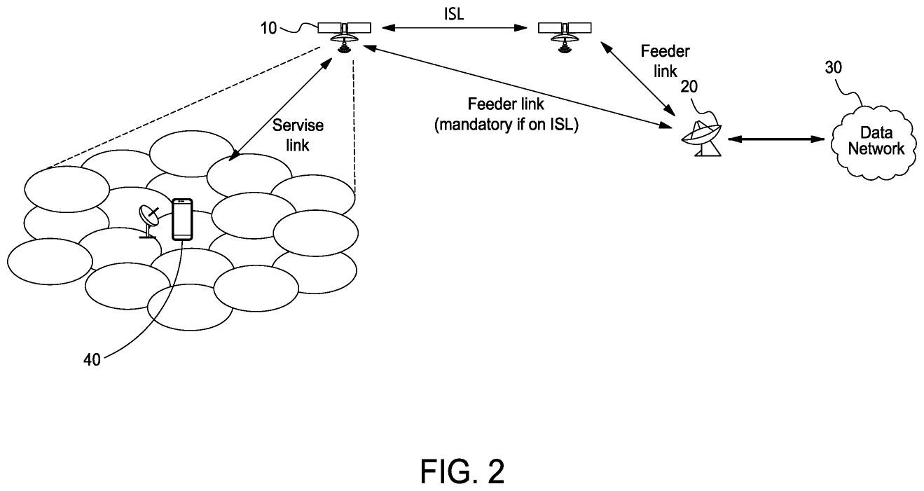

FIG. 1 is a schematic diagram illustrating a non-terrestrial network (NTN) scenario according to an example implementation of the present disclosure; FIG. 2 is a schematic diagram illustrating an NTN scenario according to another example implementation of the present disclosure.

Referring to FIG. 1 and FIG. 2, an NTN refers to a network or a segment of networks using radio frequency (RF) resources onboard one or more satellites 10. One or several sat-gateways 20 may connect the NTN to a public data network 30. At least part of the one or more satellites 10 may be replaced by an unmanned aircraft system (UAS) platform. In some cases, the one or more satellites 10 may include a geostationary earth orbit (GEO) satellite. In some cases, the one or more satellites 10 may include a non-geostationary orbit earth orbit (Non-GEO) satellite.

A GEO satellite is fed by one or several sat-gateways 20 which are deployed across the satellite targeted coverage (e.g., regional or even continental coverage). In some implementations, a UE in a cell is served by only one sat-gateway 20.

A Non-GEO satellite may be served successively by one or several sat-gateways 20 at a time. The system ensures service and feeder link continuity between the successive serving sat-gateways 20 with sufficient time duration to proceed with mobility anchoring and handover.

It is noted that a radio link called a feeder link may refer to a radio link between a sat-gateway 20 and the satellite 10 (or UAS platform). It is also noted that a radio link called a service link may refer to a radio link between the user equipment (UE) 40 and the satellite 10 (or UAS platform).

In some cases, a radio link called inter-satellite link (ISL) may be used for communication between multiple satellites 10.

A UE may be configured to report information about a UE-specific timing advance (TA) pre-compensation, e.g., during a random access (RA) procedure at initial access, when in the RRC_IDLE/RRC_INACTIVE state, and/or when in the RRC_CONNECTED state.

A UE may also be configured to report information about the UE-specific TA pre-compensation (e.g., in the RRC_CONNECTED state) in a case that the change of the TA value exceeds a threshold (e.g., a TA offset threshold).

A TA offset threshold may be used for event-triggered reporting. For example, the TA offset threshold may be set between a current UE-specific TA and the last successfully reported/stored UE-specific TA.

The UE-specific TA pre-compensation may be reported by a UE-specific TA report (TAR) media access control (MAC) control element (CE). The UE-specific TAR MAC CE may be identified by a MAC subheader with a logical channel identification (LCID).

The TA applied by an NR NTN UE in the RRC_IDLE/INACTIVE state and/or RRC_CONNECTED state may be given by:

T_{TA}=(N_{TA}+N_{TA,UE-specific}+N_{TA,common}+N_{TA,offset})×T_{c}

, where:

N_{TA} is defined as 0 for physical random access channel (PRACH) and updated based on TA Command field in msg2/msgB and the MAC CE TA command;

N_{TA,UE-specific} is a UE self-estimated TA to pre-compensate for the service link delay;

N_{TA,common} is a network-controlled common TA and may include any timing offset considered necessary by the network, where N_{TA,common} with a value of 0 is supported; and

N_{TA,offset} is a fixed offset used to calculate the timing advance.

In some implementations, a UE-specific TA Reporting (UTR) procedure may be used to provide the serving gNB (e.g., in an NTN) with information about the UE-specific TA pre-compensation.

In some implementations, a network may configure a parameter (e.g., enableTA-Report), e.g., via system information/SIB (e.g., SIB 1/specific NTN SIB/other SI) and/or via UE-specific RRC signaling, to control the UTR. The parameter may indicate whether the UTR is enabled or disabled (e.g., during an RA procedure).

In some cases, a UE may receive the parameter (e.g., enableTA-Report) via UE-specific/dedicated signaling (e.g., via an RRC message (e.g., RRC reconfiguration with sync and/or the SIB indication carried in a handover (HO) command), an MAC CE command, and/or a DCI format) to control the UTR. The parameter may indicate whether the UTR is enabled or disabled (e.g., during an RA procedure).

In some cases, if the UE does not receive any UE-specific/dedicated parameter for the TA report (e.g., enableTA-Report), the UE may assume that the parameter (e.g., enableTA-Report) is provided in system information/SIB1/NTN SIB.

In some cases, if the UE receives both a UE-specific and a cell-specific parameter for the TA report (e.g., enableTA-Report), the UE may apply the UE-specific parameter for the TA report for enabling or disabling UTR and ignore the cell-specific parameter for the TA report.

In some implementations, the UTR may be triggered for a timing advance group (TAG), a serving cell/target cell, a bandwidth part (BWP), an NTN, and/or a gNB. The TAG may be a Primary TAG (PTAG).

In some implementations, the UTR may be triggered when the UE is in the RRC_IDLE state or the RRC_INACTIVE state, or when the UE is in the RRC_CONNECTED state.

In some implementations, the UTR may be triggered when a parameter (e.g., enableTA-Report) is configured, enabled, and/or set to true.

For example, the UE may determine whether to trigger the UTR based on the parameter only when the UE is in the RRC_IDLE state or the RRC_INACTIVE state, or when the UE is in the RRC_CONNECTED state.

For example, the UE may determine whether to trigger the UTR based on the parameter only when the UE initiates an RA procedure.

In some cases, the parameter may be configured via system information (e.g., SIB 1), and/or an RRC (re)configuration message.

In some cases, the parameter may be configured via a UTR configuration.

In some cases, the parameter may be configured via an RA configuration (e.g., RACH-ConfigCommon, RACH-ConfigCommonTwoStepRA, RACH-ConfigDedicated, RACH-ConfigGeneric, and/or RACH-ConfigGenericTwoStepRA).

In some cases, the parameter may be configured via a MAC Cell Group configuration and/or a default MAC Cell Group configuration.

In some cases, the parameter may be configured differently for different TAGs, different serving cells/target cells, and/or different BWPs.

In some implementations, the UTR may be triggered when initiating an RA procedure and/or the RA procedure is triggered by one or more of the following events (a) to (m):

(a) an initial access from the RRC_IDLE state or a tracking area update (TAU) procedure;

(b) an RRC Connection Re-establishment procedure;

(c) downlink (DL) or uplink (UL) data arrival during the RRC_CONNECTED state when UL synchronization status is “non-synchronized”;

(d) UL data arrival during the RRC_CONNECTED state when there are no physical uplink control channel (PUCCH) resources for SR available;

(e) ISR failure;

(f) request by RRC upon synchronous reconfiguration (e.g., handover);

(g) an RRC Connection Resume procedure from the RRC_INACTIVE state or a random access network (RAN) notification area update procedure from the RRC_INACTIVE state;

(h) to establish time alignment for a secondary TAG;

(i) request for Other SI

(j) beam failure recovery;

(k) consistent UL listen-before-talk (LBT) failure on SpCell;

(l) a small data transmission (SDT) procedure from the RRC_INACTIVE state; and

(m) reduced capability (RedCap), slicing, and/or coverage enhancement.

In some implementations, the UTR may be triggered when initiating an RA procedure and/or the RA procedure is not triggered by one or more of the events (a) to (m) above.

In some implementations, the UTR may be triggered based on a threshold.

For example, the UTR may be triggered when the TA change between the current UE-estimated TA and the last successfully reported/stored TA is larger than the threshold.

For example, the UTR may be triggered when the TA deviation between a TA estimation based on the current UE location and a TA estimation based on the last successfully reported/stored UE location is larger than the threshold.

For example, the UTR may be triggered if, compared to the stored TA information value (e.g., a value contained in the stored TA information) at the UE's last successfully reported/stored TA, the value has increased/decreased by more than the threshold (e.g., if configured).

In some cases, the threshold may be configured via system information (e.g., SIB1), and/or an RRC configuration.

In some cases, the threshold may be configured via a UTR configuration.

In some cases, the threshold may be configured via an RA configuration (e.g., RACH-ConfigCommon, RACH-ConfigCommonTwoStepRA, RACH-ConfigDedicated, RACH-ConfigGeneric, and/or RACH-ConfigGenericTwoStepRA).

In some cases, the threshold may be configured via a MAC Cell Group configuration and/or a default MAC Cell Group configuration.

In some cases, the threshold may be configured differently for different TAGs, different serving cells/target cells, and/or different BWPs.

In some implementations, the UTR may be triggered upon configuration or reconfiguration of the UTR functionality by upper layers, e.g., which is not used to disable the function.

In some cases, the configuration may be configured via system information (e.g., SIB1), and/or an RRC configuration.

In some cases, the configuration may be configured via a UTR configuration.

In some cases, the configuration may be configured via an RA configuration (e.g., RACH-ConfigCommon, RACH-ConfigCommonTwoStepRA, RACH-ConfigDedicated, RACH-ConfigGeneric, and/or RACH-ConfigGenericTwoStepRA).

In some cases, the configuration may be configured via a MAC Cell Group configuration and/or a default MAC Cell Group configuration.

In some cases, the configuration may be configured differently for different TAGs, different serving cells/target cells, and/or different BWPs.

In some implementations, the UTR may be triggered when an activation of an SCell/(DL/UL) BWP occurs.

In some implementations, the UTR may be triggered when an addition of the PSCell (e.g., the PSCell is newly added or changed by the NW/UE).

In some implementations, the UTR may be triggered when the TA timer expires and/or when the TA timer is running and/or when the TA timer is (re)started.

In some implementations, the UTR may be triggered when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

In some implementations, the UTR may be triggered when receiving an indication from a lower layer (e.g., the PHY layer) and/or a higher layer (e.g., the RRC layer).

For example, the indication may indicate whether the TA change between the current UE-estimated TA and the last successfully reported/stored TA is larger than the threshold.

For example, the indication may indicate whether the TA deviation between a TA estimation based on the current UE location and a TA estimation based on the last successfully reported/stored UE location is larger than the threshold.

In some implementations, the UTR may be triggered when an evaluation of the UE-specific TA and/or TA pre-compensation according to the requirements as specified in TS 38.133 is completed.

In some implementations, the UTR may be triggered if a UTR prohibit timer is not running and/or if the UTR prohibit timer expires.

In some implementations, when the UE triggers the UTR and/or performs the UTR procedure, the UE may consider the TA timer as expired.

In some implementations, when the UE triggers the UTR and/or performs the UTR procedure, the UE may stop (e.g., UL) transmission.

In some implementations, the UTR may be cancelled.

In some implementations, the UTR may be cancelled when a MAC PDU is transmitted and the MAC PDU includes a UTR MAC CE.

For example, the UTR may be cancelled when a MAC PDU is transmitted and the MAC PDU includes a UTR MAC CE if the UTR is triggered based on the RA procedure and/or based on the threshold.

For example, all BSRs triggered prior to MAC PDU assembly may be cancelled when a MAC PDU is transmitted and the MAC PDU includes a UTR MAC CE which contains TA information up to (and including) the last event that triggered a UTR prior to the MAC PDU assembly.

For example, a MAC PDU may contain at most one UTR MAC CE, even when multiple events have triggered the UTR.

In some implementations, the UTR may be cancelled if the allocated UL resources can accommodate the UTR MAC CE which the MAC entity is configured to transmit, plus its subheader, as a result of logical channel prioritization (LCP).

In some implementations, the UTR may be cancelled after the UE instructs the multiplexing and assembly procedure to generate and transmit the UTR MAC CE.

In some implementations, the UTR may be cancelled when the UL grant(s) can accommodate all pending data available for transmission but is not sufficient to additionally accommodate the UTR MAC CE plus its subheader.

In some implementations, the UTR may be cancelled when a parameter (e.g., enableTA-Report) is de-configured, disabled, and/or set to false.

In some cases, the parameter may be configured via system information (e.g., SIB1), and/or an RRC (re)configuration.

In some cases, the parameter may be configured via a UTR configuration.

In some cases, the parameter may be configured via an RA configuration (e.g., RACH-ConfigCommon, RACH-ConfigCommonTwoStepRA, RACH-ConfigDedicated, RACH-ConfigGeneric, and/or RACH-ConfigGenericTwoStepRA).

In some cases, the parameter may be configured via a MAC Cell Group configuration and/or a default MAC Cell Group configuration.

In some cases, the parameter may be configured differently for different TAGs, different serving cells/target cells, and/or different BWPs.

In some implementations, the UTR may be cancelled when an RA procedure (e.g., that triggers the UTR) is stopped.

In some implementations, the UTR may be cancelled when an RA procedure (e.g., that triggers the UTR) is unsuccessfully completed.

For example, the UTR may be cancelled when the UE considers the contention resolution of the RA procedure to be unsuccessful.

In some implementations, the UTR may be cancelled when an RA procedure (e.g., that triggers the UTR) is successfully completed.

In some implementations, the UTR may be cancelled when an RA procedure is initiated and/or the RA procedure is triggered (or is not triggered) by one or more of the events (a) to (m) described above.

In some implementations, the UTR may be cancelled when the RRC state of the UE is changed.

For example, the UTR may be cancelled when the UE moves from the RRC_IDLE/RRC_INACTIVE state to the RRC_CONNECTED state.

For example, the UTR may be cancelled when the UE moves from the RRC_CONNECTED state to the RRC_IDLE/RRC_INACTIVE state.

In some implementations, the UTR may be cancelled when a deactivation of an SCell/(DL/UL) BWP occurs.

In some implementations, the UTR may be cancelled when the TA timer expires, when the TA timer is running, or when the TA timer is (re)started.

In some implementations, the UTR may be cancelled when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

In some implementations, the UTR may be cancelled when the MAC is reset.

In some implementations, the UTR may be cancelled when receiving an indication from a lower layer (e.g., the PHY layer) and/or a higher layer (e.g., the RRC layer).

For example, the indication may indicate whether a TA change between the current UE-estimated TA and the last successfully reported/stored TA is larger than the threshold.

For example, the indication may indicate whether the TA deviation between a TA estimation based on the current UE location and a TA estimation based on the last successfully reported/stored UE location is larger than the threshold.

In some implementations, the UTR may be cancelled when the UE considers that a radio link failure (RLF) is detected.

For example, in a case that an upper layer of the UE receives a specific indication from a lower layer of the UE, the upper layer of the UE may consider that an RLF is detected.

For example, in a case that a lower layer of the UE receives a specific indication from an upper layer of the UE, the lower layer of the UE may consider that an RLF is detected.

For example, the lower layer/upper layer/UE may consider that the RLF is detected for the source MCG (e.g., source RLF).

For example, the lower layer/upper layer/UE may consider that the RLF is detected for the MCG (e.g., MCG RLF).

For example, the lower layer/upper layer/UE may consider that the RLF is detected for the SCG (e.g., SCG RLF).

In some implementations, the UTR may be cancelled if a UTR prohibit timer (e.g., UTR-ProhibitTimer) is running and/or if the UTR prohibit timer is (re)started.

In some implementations, a UTR prohibit timer may be applied to prohibit the UTR.

In some implementations, the UE may (only) trigger the UTR if a UTR prohibit timer is not running and/or if the UTR prohibit timer expires.

In some implementations, UE may cancel the pending UTR if a UTR prohibit timer is (re)started.

In some cases, the UTR prohibit timer may be started or restarted when a UTR MAC CE in the subsequent uplink transmission has been sent.

In some cases, the UTR prohibit timer may be started or restarted when a UTR is triggered.

In some cases, the UTR prohibit timer may be started or restarted when MAC PDU is transmitted and the MAC PDU includes a UTR MAC CE.

In some cases, the UTR prohibit timer may be stopped if, compared to the stored TA information value (e.g., a value contained in the stored TA information) at the UE's last successfully reported/stored TA, the value has increased/decreased by more than the threshold (e.g., if configured).

The UE/MAC entity may be configured with zero, one, or more SR configurations. An SR configuration may include or consist of a set of PUCCH resources for SR across different BWPs and cells. For a UTR, at most one PUCCH resource for SR may be configured per BWP.

An SR configuration may correspond to a UTR. Each UTR may be mapped to zero or one SR configuration, which is configured by RRC. The SR configuration of the UTR may be considered to be the corresponding SR configuration for the triggered SR.

RRC may configure the following parameters for the scheduling request procedure:

sr-ProhibitTimer (per SR configuration); and

sr-TransMax (per SR configuration).

The following UE variables may be used for the scheduling request procedure:

SR_COUNTER (per SR configuration).

If an SR is triggered and there are no other SRs pending and corresponding to the same SR configuration, the MAC entity may set the SR_COUNTER of the corresponding SR configuration to 0.

When an SR is triggered, it may be considered as pending until it is cancelled.

In some implementations, when the MAC entity has a pending SR for UTR and the MAC entity has one or more PUCCH resources overlapping with the PUCCH resource for UTR for the SR transmission occasion, the MAC entity may consider only the PUCCH resource for UTR to be valid.

In some implementations, the SR for UTR may be triggered for a TAG, a serving cell/target cell, a BWP, an NTN, and/or a gNB. The TAG may be a PTAG.

In some implementations, if the UTR procedure determines that at least one UTR has been triggered and not cancelled, the UE may determine if one or more uplink shared channel (UL-SCH) resources are available for a new transmission and if the one or more UL-SCH resources can accommodate the UTR MAC CE plus its subheader as a result of LCP.

In a case that the one or more UL-SCH resources are available for a new transmission and the one or more UL-SCH resources can accommodate the UTR MAC CE plus its subheader as a result of LCP, the UE may instruct the multiplexing and assembly procedure to generate the UTR MAC CE.

In a case that the one or more UL-SCH resources are not available for a new transmission or the one or more UL-SCH resources cannot accommodate the UTR MAC CE plus its subheader as a result of LCP, the UE may trigger an SR (e.g., for UTR).

In some cases, the UL-SCH resource and/or the new transmission may be used for Msg3/MsgA/Msg5 transmission.

In some implementations, the UE may determine whether to trigger an SR (e.g., for UTR) based on a parameter. The parameter may indicate whether the UE can trigger the SR (e.g., for UTR). Specifically, the UE may determine whether to trigger the SR based on whether the parameter is configured/deconfigured, enabled/disabled, and/or set to true/false.

In some cases, the UE may (only) determine whether to trigger the UTR based on the parameter when the UE is in the RRC_IDLE state or the RRC_INACTIVE state, or when the UE is in the RRC_CONNECTED state.

In some cases, the UE may (only) determine whether to trigger the UTR based on the parameter when an RA procedure is initiated.

In some cases, the parameter may be configured via system information (e.g., SIB1), and/or an RRC configuration.

In some cases, the parameter may be configured via a UTR configuration.

In some cases, the parameter may be configured via an RA configuration (e.g., RACH-ConfigCommon, RACH-ConfigCommononTwoStepRA, RACH-ConfigDedicated, RACH-ConfigGeneric, and/or RACH-ConfigGenericTwoStepRA).

In some cases, the parameter may be configured via a MAC Cell Group configuration and/or a default MAC Cell Group configuration.

In some cases, the parameter may be configured differently for different TAGs, different serving cells/target cells, and/or different BWPs.

In some implementations, the UE may determine whether to trigger an SR (e.g., for UTR) based on by which event(s) the UTR is triggered.

For example, the UE may trigger an SR (e.g., for UTR) if the UE is in the RRC_IDLE state or the RRC_INACTIVE state, or if the UE is in the RRC_CONNECTED state.

For example, the UE may trigger an SR (e.g., for UTR) if the UTR is triggered by an RA procedure and/or the RA procedure is triggered (or is not triggered) by one or more of the events (a) to (m) described above.

For example, the UE may trigger an SR (e.g., for UTR) if the UTR is triggered based on a threshold.

In some cases, the UTR may be triggered when the TA change between the current UE-estimated TA and the last successfully reported/stored TA is larger than the threshold.

In some cases, the UTR may be triggered when the TA deviation between a TA estimation based on the current UE location and the TA estimation based on the last successfully reported/stored UE location is larger than the threshold.

In some cases, the UTR may be triggered if, compared to the stored TA information value (e.g., a value contained in the stored TA information) at the UE's last successfully reported/stored TA, the value has increased/decreased by more than the threshold (e.g., if configured).

In some cases, the threshold may be configured via system information (e.g., SIB1), and/or an RRC configuration.

In some cases, the threshold may be configured via a UTR configuration.

In some cases, the threshold may be configured via an RA configuration (e.g., RACH-ConfigCommon, RACH-ConfigCommononTwoStepRA, RACH-ConfigDedicated, RACH-ConfigGeneric, and/or RACH-ConfigGenericTwoStepRA).

In some cases, the threshold may be configured via a MAC Cell Group configuration and/or a default MAC Cell Group configuration.

In some cases, the threshold may be configured differently for different TAGs, different serving cells/target cells, and/or different BWPs.

For example, the UE may trigger an SR (e.g., for UTR) if the UTR is triggered upon a configuration or a reconfiguration of the UTR functionality by upper layers, e.g., which is not used to disable the function.

For example, the UE may trigger an SR (e.g., for UTR) if the UTR is triggered when an activation of an Scell/(DL/UL) BWP occurs.

For example, the UE may trigger an SR (e.g., for UTR) if the UTR is triggered when an addition of the PSCell (e.g., the PSCell is newly added or changed).

In some implementations, the UE may trigger an SR (e.g., for UTR) when a TA timer expires, when the TA timer is running, or when the TA timer is (re)started.

In some implementations, the UE may trigger an SR (e.g., for UTR) when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

For example, the UE may trigger an SR (e.g., for UTR) if the UTR is triggered when receiving an indication from a lower layer (e.g., the PHY layer) and/or a higher layer (e.g., the RRC layer).

For example, the UE may trigger an SR (e.g., for UTR) if the UTR is triggered when an evaluation of the UE-specific TA and/or TA pre-compensation according to the requirements as specified in TS 38.133 is completed.

In some implementations, the UE may trigger an SR (e.g., for UTR) if a UTR prohibit timer is not running and/or if the UTR prohibit timer expires.

In some implementations, the UE may trigger an SR (e.g., for UTR) if transmission of a (pending) UTR cannot fulfill the latency requirement associated to the UTR.

In some implementations, if the SR was triggered by a UTR procedure prior to the MAC PDU assembly and a MAC PDU containing the relevant UTR MAC CE is transmitted, the UE may cancel the pending SR and stop the corresponding sr-ProhibitTimer and/or stop the corresponding UTR prohibit timer, if running.

In some implementations, all pending SR(s) for UTR triggered according to the UTR procedure prior to the MAC PDU assembly may be cancelled and the respective sr-ProhibitTimer/UTR prohibit timer may be stopped when the MAC PDU is transmitted and/or the PDU includes a UTR MAC CE which contains the last event that triggered a UTR prior to the MAC PDU assembly.

In some implementations, all pending SR(s) for UTR triggered according to the UTR procedure may be cancelled and the respective sr-ProhibitTimer/UTR prohibit timer may be stopped when the UL grant(s) can accommodate all pending data available for transmission.

In some implementations, the SR triggered for UTR may be cancelled and/or the respective sr-ProhibitTimer/UTR prohibit timer may be stopped when a MAC PDU is transmitted and/or the MAC PDU includes a UTR MAC CE.

For example, the SR triggered for UTR may be cancelled and/or the respective sr-ProhibitTimer/UTR prohibit timer may be stopped when a MAC PDU is transmitted and the PDU includes a UTR MAC CE if the UTR is triggered based on an RA procedure and/or based on the threshold.

For example, the SR triggered for UTR may be cancelled and/or the respective sr-ProhibitTimer/UTR prohibit timer may be stopped when a MAC PDU is transmitted and the MAC PDU includes a UTR MAC CE which contains the TA information up to (and including) the last event that triggered a UTR prior to the MAC PDU assembly.

In some implementations, the SR triggered for UTR may be cancelled and/or the respective sr-ProhibitTimer/UTR prohibit timer may be stopped if the allocated UL resource(s) can accommodate the UTR MAC CE which the MAC entity is configured to transmit, plus its subheader, as a result of LCP.

In some implementations, the SR triggered for UTR may be cancelled and/or the respective sr-ProhibitTimer/UTR prohibit timer may be stopped after the UE instructs the multiplexing and assembly procedure to generate and transmit the UTR MAC CE.

In some implementations, the SR triggered for UTR may be cancelled and/or the respective sr-ProhibitTimer/UTR prohibit timer may be stopped and/or cancelled when a parameter (e.g., enableTA-Report) is de-configured, disabled, and/or set to false.

In some implementations, the SR triggered for UTR may be cancelled and/or the respective sr-ProhibitTimer/UTR prohibit timer may be stopped and/or cancelled when the RA procedure (e.g., that triggers the UTR) is stopped.

In some implementations, the SR triggered for UTR may be cancelled and/or the respective sr-ProhibitTimer/UTR prohibit timer may be stopped when the RA procedure (e.g., that triggers the UTR) is unsuccessfully completed.

For example, the UTR may be cancelled when the UE considers the contention resolution of the RA procedure to be unsuccessful.

In some implementations, the SR triggered for UTR may be cancelled and/or the respective sr-ProhibitTimer/UTR prohibit timer may be stopped when the RA procedure (e.g., that triggers the UTR) is successfully completed.

In some implementations, the SR triggered for UTR may be cancelled and/or the respective sr-ProhibitTimer/UTR prohibit timer may be stopped when the RA procedure is initiated and/or the RA procedure is triggered (or is not triggered) by one or more of the events (a) to (m) as described above.

In some implementations, the SR triggered for UTR may be cancelled and/or the respective sr-ProhibitTimer/UTR prohibit timer may be stopped when the RRC state of the UE is changed.

For example, the UTR may be cancelled when the UE moves from the RRC_IDLE/RRC_INACTIVE state to the RRC_CONNECTED state.

For example, the UTR may be cancelled when the UE moves from the RRC_CONNECTED state to the RRC_IDLE/RRC_INACTIVE state.

In some implementations, the SR triggered for UTR may be cancelled and/or the respective sr-ProhibitTimer/UTR prohibit timer may be stopped when a deactivation of an SCell/BWP occurs.

In some implementations, the SR triggered for UTR may be cancelled and/or the respective sr-ProhibitTimer/UTR prohibit timer may be stopped when the TA timer expires, when the TA timer is running, or when the TA timer is (re)started.

In some implementations, the SR triggered for UTR may be cancelled and/or the respective sr-ProhibitTimer/UTR prohibit timer may be stopped when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

In some implementations, the SR triggered for UTR may be cancelled and/or the respective sr-ProhibitTimer/UTR prohibit timer may be stopped when the MAC is reset.

In some implementations, the SR triggered for UTR may be cancelled and/or the respective sr-ProhibitTimer/UTR prohibit timer may be stopped when receiving an indication from a lower layer (e.g., the PHY layer) and/or a higher layer (e.g., the RRC layer).

For example, the indication may indicate whether the TA change between the current UE-estimated TA and the last successfully reported/stored TA is larger than the threshold.

For example, the indication may indicate whether the TA deviation between a TA estimation based on the current UE location and a TA estimation based on the last successfully reported/stored UE location is larger than the threshold.

In some implementations, as long as at least one SR is pending, the MAC entity may determine if the UE/MAC entity has no valid PUCCH resource configured for the pending SR.

In a case that the UE determines that the UE/MAC entity has no valid PUCCH resource configured for the pending SR, the UE may initiate an RA procedure on the SpCell and cancel the pending SR and/or stop the corresponding sr-ProhibitTimer/UTR prohibit timer.

In some implementations, if SR_COUNTER>=sr-TransMax, the UE may initiate an RA procedure on the SpCell and cancel all pending SRs and/or stop the corresponding sr-ProhibitTimer/UTR prohibit timer.

In some implementations, the RA for UTR may be triggered for a TAG, a serving cell/target cell, a BWP, an NTN, and/or a gNB. The TAG may be a PTAG.

In some implementations, the UE may stop an ongoing RA procedure due to a pending SR for UTR (e.g., which was initiated by the UE/MAC entity prior to the MAC PDU assembly and has no valid PUCCH resources configured) if a MAC PDU is transmitted (e.g., using a UL grant other than a UL grant provided by RAR and/or a UL grant for the transmission of the MSGA payload), and/or the MAC PDU includes a UTR MAC CE which contains TA information, e.g., up to (and/or including) the last event that triggered a UTR prior to the MAC PDU assembly.

In some implementations, the UE may stop an ongoing RA procedure due to a pending SR for UTR (e.g., which was initiated by the UE/MAC entity prior to the MAC PDU assembly and which has no valid PUCCH resources configured).

In some implementations, the ongoing RA procedure due to a pending SR for UTR may be stopped when a MAC PDU is transmitted and the MAC PDU includes a UTR MAC CE.

For example, the ongoing RA procedure due to a pending SR for UTR may be stopped when a MAC PDU is transmitted and the MAC PDU includes a UTR MAC CE if the UTR is triggered based on the RA procedure and/or based on the threshold.

For example, the ongoing RA procedure due to a pending SR for UTR may be stopped when a MAC PDU is transmitted and the MAC PDU includes a UTR MAC CE which contains the TA information up to (and including) the last event that triggered a UTR prior to the MAC PDU assembly.

In some implementations, the ongoing RA procedure due to a pending SR for UTR may be stopped if the allocated UL resource(s) can accommodate the UTR MAC CE which the MAC entity is configured to transmit, plus its subheader, as a result of LCP.

In some implementations, the ongoing RA procedure due to a pending SR for UTR may be stopped after the UE instructs the multiplexing and assembly procedure to generate and transmit the UTR MAC CE.

In some implementations, the ongoing RA procedure due to a pending SR for UTR may be stopped when a parameter (e.g., enableTA-Report) is de-configured, disabled, and/or set to false.

In some implementations, the ongoing RA procedure due to a pending SR for UTR may be stopped when an RA procedure (e.g., that triggers the UTR) is stopped.

In some implementations, the ongoing RA procedure due to a pending SR for UTR may be stopped when an RA procedure (e.g., that triggers the UTR) is unsuccessfully completed.

For example, the UTR may be cancelled when the UE considers the contention resolution of the RA procedure to be unsuccessful.

In some implementations, the ongoing RA procedure due to a pending SR for UTR may be stopped when an RA procedure (e.g., that triggers the UTR) is successfully completed.

In some implementations, the ongoing RA procedure due to a pending SR for UTR may be stopped when an RA procedure is initiated and the RA procedure is triggered (or is not triggered) by one or more of the events (a) to (m) described above.

In some implementations, the ongoing RA procedure due to a pending SR for UTR may be stopped when the RRC state of the UE is changed.

For example, the UTR may be cancelled when the UE moves from the RRC_IDLE/RRC_INACTIVE state to the RRC_CONNECTED state.

For example, the UTR may be cancelled when the UE moves from the RRC_CONNECTED state to the RRC_IDLE/RRC_INACTIVE state.

In some implementations, the ongoing RA procedure due to a pending SR for UTR may be stopped when a deactivation of an SCell/BWP occurs.

In some implementations, the ongoing RA procedure due to a pending SR for UTR may be stopped when the TA timer expires, when the TA timer is running, or when the TA timer is (re)started.

In some implementations, the ongoing RA procedure due to a pending SR for UTR may be stopped when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

In some implementations, the ongoing RA procedure due to a pending SR for UTR may be stopped when the MAC is reset.

In some implementations, the ongoing RA procedure due to a pending SR for UTR may be stopped when receiving an indication from a lower layer (e.g., the PHY layer) and/or a higher layer (e.g., the RRC layer).

For example, the indication may indicate whether the TA change between the current UE-estimated TA and the last successfully reported/stored TA is larger than the threshold.

For example, the indication may indicate whether the TA deviation between a TA estimation based on the current UE location and a TA estimation based on the last successfully reported/stored UE location is larger than the threshold.

A UE variable (e.g., UE_REPORTED_TA) may be used by the UE to determine whether to trigger the UTR procedure, e.g., by comparing the value of the current/latest UE-specific TA to the value stored in the UE variable.

The UE may maintain a UE variable (e.g., UE_REPORTED_TA) to store the last successfully reported/stored TA.

In some implementations, the UE variable for UTR may be maintained for a TAG, a serving cell/target cell, a BWP, an NTN, and/or a gNB. The TAG may be a PTAG.

The UTR may be triggered based on a threshold.

For example, the UTR may be triggered when the TA change between the current UE-estimated TA and the last successfully reported/stored TA is larger than the threshold.

For example, the UTR may be triggered when the TA deviation between a TA estimation based on the current UE location and a TA estimation based on the last successfully reported/stored UE location is larger than the threshold.

In some implementations, the UE may store/set the UE variable (e.g., UE_REPORTED_TA) to TA information (e.g., the last successfully reported/stored TA information).

In some implementations, the UE may store/set the UE variable (e.g., UE_REPORTED_TA) to TA information (e.g., the last successfully reported/stored TA information) when the UE instructs the multiplexing and assembly procedure to generate and/or transmit the UTR MAC CE.

In some implementations, the UE may store/set the UE variable (e.g., UE_REPORTED_TA) to TA information (e.g., the last successfully reported/stored TA information) when the allocated UL resource(s) can accommodate the UTR MAC CE which the MAC entity is configured to transmit, plus its subheader, as a result of LCP.

In some implementations, the UE may store/set the UE variable (e.g., UE_REPORTED_TA) to TA information (e.g., the last successfully reported/stored TA information) when the UTR MAC CE is transmitted successfully.

In some implementations, the UE may store/set the UE variable (e.g., UE_REPORTED_TA) to TA information (e.g., the last successfully reported/stored TA information) when receiving a TA command (e.g., TA command MAC CE).

In some implementations, the UE may store/set the UE variable (e.g., UE_REPORTED_TA) to TA information (e.g., the last successfully reported/stored TA information) when the UE triggers a UTR procedure.

In some implementations, the UE may store/set the UE variable (e.g., UE_REPORTED_TA) to TA information (e.g., the last successfully reported/stored TA information) when the UE initiates an RA procedure (e.g., for UTR) and/or the RA procedure is triggered (or is not triggered) by one or more of the events (a) to (m) described above.

In some implementations, the UE may store/set the UE variable (e.g., UE_REPORTED_TA) to TA information (e.g., the last successfully reported/stored TA information) when a parameter (e.g., enableTA-Report) is configured, enabled, and/or set to true.

In some implementations, the UE may store/set the UE variable (e.g., UE_REPORTED_TA) to TA information (e.g., the last successfully reported/stored TA information) upon a configuration or a reconfiguration of the UTR functionality by upper layers, e.g., which is not used to disable the function.

In some cases, the configuration may be configured via system information (e.g., SIB1) and/or an RRC configuration.

In some cases, the configuration may be configured via a UTR configuration.

In some cases, the configuration may be configured via an RA configuration (e.g., RACH-ConfigCommon, RACH-ConfigCommonTwoStepRA, RACH-ConfigDedicated, RACH-ConfigGeneric, and/or RACH-ConfigGenericTwoStepRA).

In some cases, the configuration may be configured via a MAC Cell Group configuration and/or a default MAC Cell Group configuration.

In some cases, the configuration may be configured differently for different TAGs, different serving cells/target cells, and/or different BWPs.

In some implementations, the UE may store/set the UE variable (e.g., UE_REPORTED_TA) to TA information (e.g., the last successfully reported/stored TA information) when an activation of an SCell/BWP occurs.

In some implementations, the UE may store/set the UE variable (e.g., UE_REPORTED_TA) to TA information (e.g., the last successfully reported/stored TA information) when an addition of the PSCell (e.g., the PSCell is newly added or changed).

In some implementations, the UE may store/set the UE variable (e.g., UE_REPORTED_TA) to TA information (e.g., the last successfully reported/stored TA information) when a TA timer expires, when the TA timer is running, or when the TA timer is (re)started.

In some implementations, the UE may store/set the UE variable (e.g., UE_REPORTED_TA) to TA information (e.g., the last successfully reported/stored TA information) when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

In some implementations, the UE may store/set the UE variable (e.g., UE_REPORTED_TA) to TA information (e.g., the last successfully reported/stored TA information) when receiving an indication from a lower layer (e.g., the PHY layer) and/or a higher layer (e.g., the RRC layer).

For example, the indication may indicate the TA information.

For example, the indication may indicate whether the TA change between the current UE-estimated TA and the last successfully reported/stored TA is larger than the threshold.

For example, the indication may indicate whether the TA deviation between a TA estimation based on the current UE location and a TA estimation based on the last successfully reported/stored UE location is larger than the threshold.

In some implementations, the UE may store/set the UE variable (e.g., UE_REPORTED_TA) to TA information (e.g., the last successfully reported/stored TA information) when an evaluation of the UE-specific TA and/or TA pre-compensation according to the requirements as specified in TS 38.133 is completed.

For example, the TA information may be derived from a lower layer (e.g., the PHY layer).

In some implementations, the UE may clear/flush/release/reset the UE variable (e.g., UE_REPORTED_TA).

In some implementations, the UE may clear/flush/release/reset the UE variable (e.g., UE_REPORTED_TA) upon a configuration or reconfiguration of the UTR functionality by upper layers, e.g., which is not used to disable the function.

In some cases, the configuration may be configured via system information (e.g., SIB1), and/or an RRC configuration.

In some cases, the configuration may be configured via a UTR configuration.

In some cases, the configuration may be configured via an RA configuration (e.g., RACH-ConfigCommon, RACH-ConfigCommonTwoStepRA, RACH-ConfigDedicated, RACH-ConfigGeneric, and/or RACH-ConfigGenericTwoStepRA).

In some cases, the configuration may be configured via a MAC Cell Group configuration and/or a default MAC Cell Group configuration.

In some cases, the configuration may be configured differently for different TAGs, different serving cells/target cells, and/or different BWPs.

In some implementations, the UE may clear/flush/release/reset the UE variable (e.g., UE_REPORTED_TA) when a parameter (e.g., enableTA-Report) is modified/de-configured, disabled, and/or set to false.

In some implementations, the UE may clear/flush/release/reset the UE variable (e.g., UE_REPORTED_TA) when a parameter (e.g., enableTA-Report) is configured, enabled, and/or set to true.

In some implementations, the UE may clear/flush/release/reset the UE variable (e.g., UE_REPORTED_TA) when receiving a TA command (e.g., TA command MAC CE).

In some implementations, the UE may clear/flush/release/reset the UE variable (e.g., UE_REPORTED_TA) when an RA procedure is initiated and the RA procedure is triggered (or is not triggered) by one or more of the events (a) to (m) described above.

In some implementations, the UE may clear/flush/release/reset the UE variable (e.g., UE_REPORTED_TA) when an RA procedure (e.g., that triggers the UTR) is stopped.

In some implementations, the UE may clear/flush/release/reset the UE variable (e.g., UE_REPORTED_TA) when an RA procedure (e.g., that triggers the UTR) is unsuccessfully completed.

In some implementations, the UE may clear/flush/release/reset the UE variable (e.g., UE_REPORTED_TA) when an RA procedure (e.g., that triggers the UTR) is successfully completed.

In some implementations, the UE may clear/flush/release/reset the UE variable (e.g., UE_REPORTED_TA) when the RRC state of the UE is changed.

For example, the UTR may be cancelled when the UE moves from the RRC_IDLE/RRC_INACTIVE state to the RRC_CONNECTED state.

For example, the UTR may be cancelled when the UE moves from the RRC_CONNECTED state to the RRC_IDLE/RRC_INACTIVE state.

In some implementations, the UE may clear/flush/release/reset the UE variable (e.g., UE_REPORTED_TA) when a deactivation of an SCell/BWP occurs.

In some implementations, the UE may clear/flush/release/reset the UE variable (e.g., UE_REPORTED_TA) when a TA timer expires, when the TA timer is running, or when the TA timer is (re)started.

In some implementations, t the UE may clear/flush/release/reset the UE variable (e.g., UE_REPORTED_TA) when a validity timer expires, when the validity timer is running, or when the validity timer is (re)started.

The validity timer may be for both serving satellite ephemeris and/or common TA-related parameters being broadcast on the SIB.

The validity timer may be started/restarted with a configured timer validity duration at the epoch time of the assistance information (e.g., serving satellite ephemeris data).

The UE may assume that it has lost uplink synchronization if new or additional assistance information (e.g., serving satellite ephemeris data or common TA parameters) is not available within the associated validity duration.

The validity duration may be configured per cell and indicated to the UE in X bits with a value of the value set {5, 10, 15, 20, 25, 30, 35, 40, 45, 50, 55, 60, 120, 180, 240}, and the unit is second.

In some implementations, the UE may clear/flush/release/reset the UE variable (e.g., UE_REPORTED_TA) when the MAC (associated with MCG or SCG) is reset.

In some implementations, the UE may clear/flush/release/reset the UE variable (e.g., UE_REPORTED_TA) when receiving an indication from a lower layer (e.g., the PHY layer) and/or a higher layer (e.g., the RRC layer). For example, the indication may indicate TA information.

In some implementations, the UE may clear/flush/release/reset the UE variable (e.g., UE_REPORTED_TA) when the UE considers that an RLF is detected.

For example, resetting the UE variable (e.g., UE_REPORTED_TA) may include setting the UE variable (e.g., UE_REPORTED_TA) to an initial value (e.g., 0 or 1).

In some implementations, the UE variable may be released/reset during a full configuration in the RRC entity.

The UTR MAC CE may be identified by MAC subheader with an LCID.

The UTR MAC CE may have a fixed size and consists of a single field.

The field of the UTR MAC CE may include a UE estimation of the UE-specific TA (e.g., to pre-compensate for the service link delay).

The unit of UE-specific TA may be symbol, slot, subframe, system frame, millisecond (ms), second, etc.

In some implementations, the UTR MAC CE may further indicate/contain/include one or more pieces of information.

In some implementations, the UTR MAC CE may include TAG information.

The TAG information may be a TAG Identity (TAG ID), e.g., indicating the TAG Identity of the addressed TAG. The TAG containing the SpCell has the TAG Identity 0. The length of the TAG may be 2 bits.

The TAG may be a primary TAG (PTAG) and/or secondary TAG (STAG).

In some implementations, the UTR MAC CE may include Serving Cell/target cell information.

The Serving Cell/target cell information may be Serving Cell/target cell ID, e.g., indicating the identity of the Serving Cell/target cell for which the MAC CE applies.

In some implementations, the UTR MAC CE may include BWP information.

The BWP information may be BWP ID, e.g., indicating a BWP for which the MAC CE applies as the codepoint of the DCI bandwidth part indicator field as specified in TS 38.212. The length of the BWP ID field may be 2 bits.

In some implementations, the UTR MAC CE may include NTA information.

The NTA may indicate a timing advance between downlink and uplink.

The NTA may be maintained (as specified in TS 38.211) per TAG or for all TAGs.

In some implementations, the UTR MAC CE may include TA offset information.

The TA offset may be a fixed offset used to calculate the timing advance.

In some implementations, the UTR MAC CE may include common TA information.

The common TA may include any timing offset considered necessary by the network.

In some implementations, the NTN cells may be configured as part of a Master Cell Group (MCG) or part of a Secondary Cell Group (SCG). Therefore, the UE may maintain one UTR (signaling/procedure) in each MAC entity associated with one Cell Group (e.g., MCG/SCG).

In some implementations, the UTR MAC CE may be generated to be associated with one Cell Group (e.g., MCG/SCG).

In some implementations, the UE may transmit the UTR MAC CE associated with one Cell Group only to the serving cells/target cells (e.g., special cell/SCells) belonging to the same Cell Group that associated with the UTR MAC CE.

In some implementations, the UE may maintain one or more timing advance groups (e.g., PTAG and/or STAG).

In some implementations, the UTR MAC CE may be generated to be associated with one TAG.

In some implementations, the UE may transmit the UTR MAC CE associated with one TAG only to the serving cells/target cells (e.g., special cell/SCells) belonging to the same TAG that is associated with the UTR MAC CE.

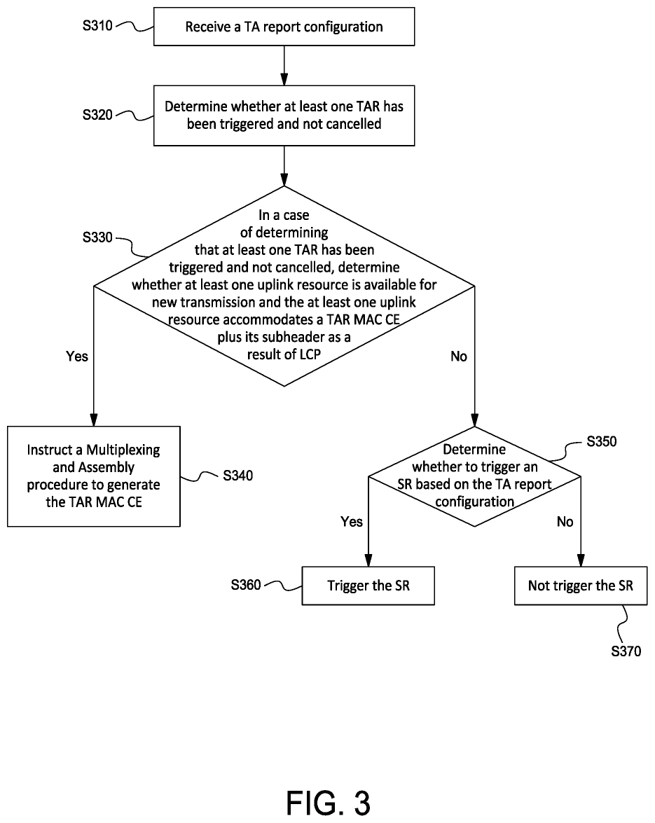

FIG. 3 is a flowchart illustrating a method for triggering an SR according to an example implementation of the present disclosure.

The method described with reference to FIG. 3 is performed by a UE operating in an NTN. Several terms, configurations, operations, mechanisms, progress, and conceptions described in the previous descriptions are not repeated when describing the method.

Referring to FIG. 3, in action S310, a timing advance (TA) report configuration may be received.

In some implementations, the TA report configuration may be received via an RRC mes sage.

In some implementations, the TA report configuration may be received via system information (e.g., SIB1).

In some implementations, the TA report configuration includes a threshold used for determination of whether to trigger a TA reporting procedure (e.g., TA offset threshold).

In some implementations, the TA report configuration includes a parameter indicating whether to trigger an SR for a TAR procedure. For example, a value of the parameter indicates whether the SR for TAR is enabled or disabled.

Turning back to FIG. 3, in action S320, the UE may determine whether at least one TAR has been triggered and not cancelled. In a case of determining that at least one TAR has been triggered and not cancelled, proceed to action S330.

In action S330, the UE may determine whether at least one UL resource is available for new transmission and the at least one UL resource accommodates a TAR MAC CE and a subheader of the TAR MAC CE as a result of LCP. The TAR MAC CE is associated with (only) one of the at least one TAR that has been triggered and not cancelled.

Specifically, the UE may be allocated with one or more UL resources. Within the allocated one or more UL resources, the UE may check whether there are any UL resources available for a new transmission. If at least one UL resource available for the new transmission is found, the UE may further determine whether the at least one UL resource found can accommodate a TAR MAC CE plus its subheader as a result of LCP, where the TAR MAC CE is associated with (only) one of the at least one TAR that has been triggered and not cancelled.

In a case of determining that at least one UL resource is available for the new transmission and the at least one UL resource accommodates a TAR MAC CE and a subheader of the TAR MAC CE as a result of LCP, proceed to action S340; otherwise, proceed to action S350.

In action S340, the MAC entity of the UE may instruct a multiplexing and assembly procedure to generate the TAR MAC CE. The generated TAR MAC CE may be, for example, transmitted via one of the at least one UL resource available for the new transmission that can accommodate the TAR MAC CE plus its subheader.

In action S350, the UE may determine whether to trigger an SR based on the TA report configuration. Specifically, the SR is for requesting UL resource(s) for transmission of the TAR MAC CE, for example. In a case of determining to trigger the SR based on the TA report configuration, proceed to action S360; otherwise, proceed to action S370.

In some implementations, the determination of whether to trigger the SR may be based on a parameter that is included in the TA report configuration and that indicates whether to trigger the SR for a TAR procedure. For example, in a case that the parameter indicating whether to trigger the SR for a TAR procedure is configured with a value of enabled, the UE may determine to trigger the SR; in a case that the parameter indicating whether to trigger the SR for a TAR procedure is configured with a value of disabled, the UE may determine not to trigger the SR.

In action S360, the MAC entity of the UE may trigger the SR for the TAR procedure.

In action S370, the MAC entity of the UE may not trigger the SR for the TAR procedure.

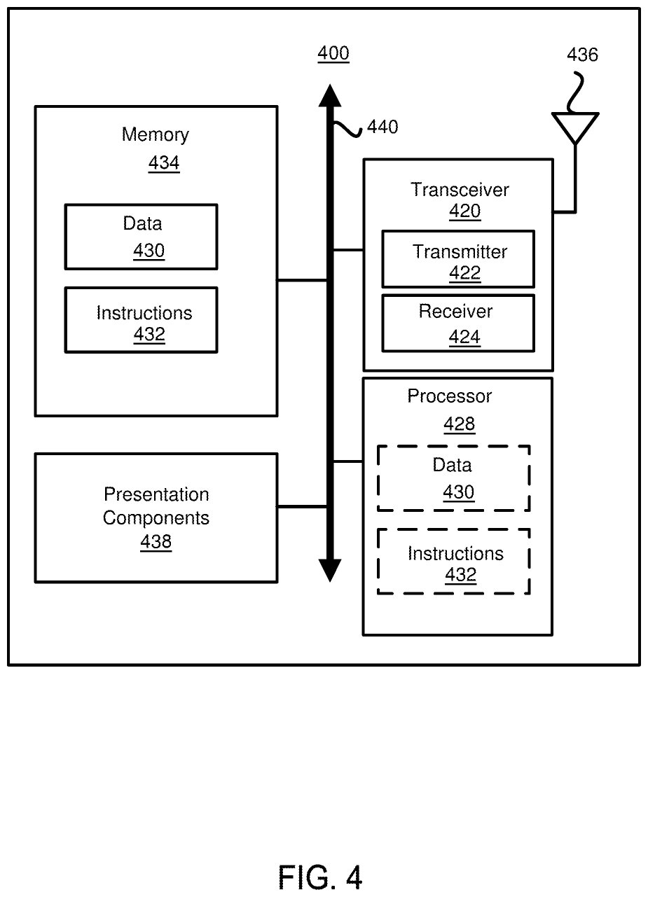

FIG. 4 is a block diagram illustrating a node for wireless communication according to an example implementation of the present disclosure.

As illustrated in FIG. 4, the node 400 may include a transceiver 420, a processor 428, a memory 434, one or more presentation components 438, and at least one antenna 436. The node 400 may also include an RF spectrum band module, a BS communications module, a network communications module, and a system communications management module, Input/Output (I/O) ports, I/O components, and a power supply (not explicitly illustrated in FIG. 4). Each of these components may be in communication with each other, directly or indirectly, over one or more buses 440. In some implementations, the node 400 may be a UE or a BS that performs various functions described herein, for example, with reference to FIGS. 1 through 3.

The transceiver 420 having a transmitter 422 (e.g., transmitting/transmission circuitry) and a receiver 424 (e.g., receiving/reception circuitry) may be configured to transmit and/or receive time and/or frequency resource partitioning information. In some implementations, the transceiver 420 may be configured to transmit in different types of subframes and slots, including, but not limited to, usable, non-usable, and flexibly usable subframes and slot formats. The transceiver 420 may be configured to receive data and control channels.

The node 400 may include a variety of computer-readable media. Computer-readable media can be any available media that can be accessed by the node 400 and include both volatile (and non-volatile) media and removable (and non-removable) media. By way of example, and not limitation, computer-readable media may include computer storage media and communication media. Computer storage media may include both volatile (and/or non-volatile) and removable (and/or non-removable) media implemented according to any method or technology for storage of information such as computer-readable instructions, data structures, program modules, or data.

Computer storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media do not include a propagated data signal. Communication media may typically embody computer-readable instructions, data structures, program modules, or other data in a modulated data signal, such as a carrier wave, or other transport mechanisms and include any information delivery media. The term “modulated data signal” may mean a signal that has one or more of its characteristics set or changed in such a manner as to encode information in the signal. By way of example, and not limitation, communication media may include wired media, such as a wired network or direct-wired connection, and wireless media, such as acoustic, RF, infrared, and other wireless media. Combinations of any of the above should also be included within the scope of computer-readable media.

The memory 434 may include computer storage media in the form of volatile and/or non-volatile memory. The memory 434 may be removable, non-removable, or a combination thereof. For example, the memory 434 may include solid-state memory, hard drives, optical-disc drives, etc. As illustrated in FIG. 4, the memory 434 may store computer-readable and/or computer-executable instructions 432 (e.g., software code(s) or computer-executable program(s)) that are configured to, when executed, cause the processor 428 to perform various functions described herein, for example, with reference to FIGS. 1 through 3. Alternatively, the instructions 432 may not be directly executable by the processor 428 but may be configured to cause the node 400 (e.g., when compiled and executed) to perform various functions described herein.

The processor 428 (e.g., having processing circuitry) may include an intelligent hardware device, a Central Processing Unit (CPU), a microcontroller, an ASIC, etc. The processor 428 may include memory. The processor 428 may process the data 430 and the instructions 432 received from the memory 434, and information through the transceiver 420, the baseband communications module, and/or the network communications module. The processor 428 may also process information to be sent to the transceiver 420 for transmission through the antenna 436, to the network communications module for transmission to a CN.

One or more presentation components 438 may present data indications to a person or other devices. Examples of presentation components 438 may include a display device, speaker, printing component, vibrating component, etc.

From the present disclosure, it is manifested that various techniques may be used for implementing the concepts described in the present disclosure without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present disclosure is not limited to the particular implementations described above. Still, many rearrangements, modifications, and substitutions are possible without departing from the scope of the present disclosure.

What is claimed is:

1. A method performed by a User Equipment (UE), the method comprising:
receiving a timing advance (TA) report configuration;
determining whether at least one TA report (TAR) has been triggered and not cancelled;
in a case of determining that the at least one TAR has been triggered and not cancelled, determining whether at least one uplink resource is available for a new transmission and the at least one uplink resource accommodates a TAR Media Access Control (MAC) Control Element (CE) and a subheader of the TAR MAC CE as a result of logical channel prioritization (LCP); and
in a case of determining that no uplink resource is available for the new transmission, or the at least one uplink resource available for the new transmission does not accommodate the TAR MAC CE and the subheader of the TAR MAC CE as a result of LCP, determining whether to trigger a scheduling request (SR) based on the TA report configuration.

2. The method of claim 1, wherein the TA report configuration comprises a parameter indicating whether to trigger the SR for a TA reporting procedure.

3. The method of claim 2, wherein determining whether to trigger the SR based on the TA report configuration comprises:
determining whether the parameter is configured with a value of enabled.

4. The method of claim 3, further comprising:
in a case of determining that the parameter is configured with the value of enabled, triggering the SR.

5. The method of claim 1, further comprising:
in a case of determining that the at least one uplink resource is available for the new transmission and the at least one uplink resource accommodates the TAR MAC CE and the subheader of the TAR MAC CE as a result of LCP, instructing a multiplexing and assembly procedure to generate the TAR MAC CE.

6. The method of claim 1, wherein the TAR MAC CE is associated with one of the at least one TAR that has been triggered and not cancelled.

7. The method of claim 1, wherein the UE operates in a non-terrestrial network (NTN).

8. A User Equipment (UE), comprising:
one or more non-transitory computer-readable media storing computer-executable instructions; and
at least one processor coupled to the one or more non-transitory computer-readable media, the at least one processor configured to execute the computer-executable instructions to cause the UE to:
receive a timing advance (TA) report configuration;
determine whether at least one TA report (TAR) has been triggered and not cancelled;
in a case of determining that the at least one TAR has been triggered and not cancelled, determine whether at least one uplink resource is available for a new transmission and the at least one uplink resource accommodates a TAR Media Access Control (MAC) Control Element (CE) and a subheader of the TAR MAC CE as a result of logical channel prioritization (LCP); and
in a case of determining that no uplink resource is available for the new transmission, or the at least one uplink resource available for the new transmission does not accommodate the TAR MAC CE and the subheader of the TAR MAC CE as a result of LCP, determine whether to trigger a scheduling request (SR) based on the TA report configuration.

9. The UE of claim 8, wherein the TA report configuration comprises a parameter indicating whether to trigger the SR for a TA reporting procedure.

10. The UE of claim 9, wherein determining whether to trigger the SR based on the TA report configuration comprises:
determining whether the parameter is configured with a value of enabled.

11. The UE of claim 10, wherein the at least one processor is further configured to execute the computer-executable instructions to cause the UE to:
in a case of determining that the parameter is configured with the value of enabled, trigger the SR.

12. The UE of claim 8, wherein the at least one processor is further configured to execute the computer-executable instructions to cause the UE to
in a case of determining that the at least one uplink resource is available for the new transmission and the at least one uplink resource accommodates the TAR MAC CE and the subheader of the TAR MAC CE as a result of LCP, instruct a multiplexing and assembly procedure to generate the TAR MAC CE.

13. The UE of claim 8, wherein the TAR MAC CE is associated with one of the at least one TAR that has been triggered and not cancelled.

14. The UE of claim 8, wherein the UE operates in a non-terrestrial network (NTN).

15. A Base Station (BS), comprising:
one or more non-transitory computer-readable media storing computer-executable instructions; and
at least one processor coupled to the one or more non-transitory computer-readable media, the at least one processor configured to execute the computer-executable instructions to cause the BS to:
transmit a timing advance (TA) report configuration to a User Equipment (UE), wherein the TA report configuration causes the UE to:
determine whether at least one TA report (TAR) has been triggered and not cancelled;
in a case of determining that the at least one TAR has been triggered and not cancelled, determine whether at least one uplink resource is available for a new transmission and the at least one uplink resource accommodates a TAR Media Access Control (MAC) Control Element (CE) and a subheader of the TAR MAC CE as a result of logical channel prioritization (LCP); and
in a case of determining that no uplink resource is available for the new transmission, or the at least one uplink resource available for the new transmission does not accommodate the TAR MAC CE and the subheader of the TAR MAC CE as a result of LCP, determine whether to trigger a scheduling request (SR) based on the TA report configuration.

16. The BS of claim 15, wherein the TA report configuration comprises a parameter indicating whether to trigger the SR for a TA reporting procedure.

17. The BS of claim 16, wherein determining whether to trigger the SR based on the TA report configuration comprises:
determining whether the parameter is configured with a value of enabled.

18. The BS of claim 17, wherein the TA report configuration further causes the UE to:
in a case of determining that the parameter is configured with the value of enabled, trigger the SR.

19. The BS of claim 15, wherein the TA report configuration further causes the UE to:
In a case of determining that the at least one uplink resource is available for the new transmission and the at least one uplink resource accommodates the TAR MAC CE and the subheader of the TAR MAC CE as a result of LCP, instruct a multiplexing and assembly procedure to generate the TAR MAC CE.

20. The BS of claim 15, wherein the TAR MAC CE is associated with one of the at least one TAR that has been triggered and not cancelled.

21. The BS of claim 15, wherein the UE operates in a non-terrestrial network (NTN).
